(19) United States
(12) Patent Application Publication
(10) Pub. No.: US 2026/0351209 A1
(43) Pub. Date: Nov. 5, 2026

(54) ELECTROPHORETIC DISPLAY APPARATUS AND METHOD OF CONTROLLING ELECTROPHORETIC DISPLAY APPARATUS

(71) Applicant: SAMSUNG ELECTRONICS CO., LTD., Suwon-si (KR)

(72) Inventor: Jinoh KIM, Suwon-si (KR)

(73) Assignee: SAMSUNG ELECTRONICS CO., LTD., Suwon-si (KR)

(21) Appl. No.: 19/724,193

(22) Filed: Jun. 29, 2026

Related U.S. Application Data
(63) Continuation of application No. PCT/KR2026/003818, filed on Mar. 10, 2026.

(30) Foreign Application Priority Data
Mar. 24, 2025 (KR) 10-2025-0037598

(51) Int. Cl. G09G 3/34; G02F 1/167; G02F 1/1676

(52) U.S. Cl. CPC G09G 3/344; G02F 1/167; G02F 1/1676; G09G 2320/0242; G09G 2320/0257; G09G 2320/041; G09G 2330/021; G09G 2330/026

(57) ABSTRACT

An electrophoretic display apparatus to display images includes a common electrode supplied with a common voltage and a pixel electrode arranged to correspond to the common electrode. A plurality of color pigments between the common electrode and the pixel electrode are dispersed in a solvent. A data driver is configured to supply a data voltage to the pixel electrode. A voltage compensator is configured to compensate for a driving voltage supplied to the data driver. A first sensor portion and a second sensor portion are configured to repeatedly detect a first detection data and a second detection data, respectively. A memory is configured to accumulatively store the first detection data and the second detection data as an accumulated first detection data and an accumulated second detection, respectively. A controller is configured to control the voltage compensator to compensate for the driving voltage by supplying a compensation voltage.

### CROSS-REFERENCE TO RELATED APPLICATIONS:

This application is a continuation application, under 35 U.S.C. § 111(a), of international application No. PCT/KR2026/003818, filed Mar. 10, 2026, which claims priority under 35 U.S.C. § 119 to Korean Patent Application No. 10-2025-0037598, filed Mar. 24, 2025, the disclosures of all of which are incorporated herein by reference in their entireties.

### TECHNICAL FIELD

The present disclosure relates to an electrophoretic display apparatus and a method of controlling the electrophoretic display apparatus.

### BACKGROUND ART

Electrophoretic Display (EPD) is a display technology that utilizes the electrophoretic phenomenon to display characters or images by moving charged microparticles with an electric field. When an electric field is applied, the particles move, and colors appear. Even when the electric field is removed, the EPD maintains its state, and no power consumes on a still screen. Due to the low-power characteristic, the EPD is widely used in electronic paper (e-paper) devices such as e-book readers.

In order to reproducibly align or initialize a plurality of color pigments dispersed in a solvent between a common electrode and a pixel electrode of a display panel of an electrophoretic display apparatus to a specific position, a high positive and negative voltage is switched at high speed to the pixel electrode.

Conventional display panels typically exhibit changes in electrical properties thereof, such as color pigments, solvents, and switching elements, due to high/low temperature environments or prolonged operation. Accordingly, it is difficult for conventional drive waveforms to move color pigments at the desired speed and position, resulting in degraded image quality and visual discomfort due to flickering during operation. Therefore, power consumption is increased. These issues ultimately lead to increased display panel power consumption, as well as reduced product life and reliability.

### DISCLOSURE

### Technical Problem

The present disclosure is directed to providing an electrophoretic display apparatus capable of improving product life and reliability, and a method of controlling the electrophoretic display apparatus.

Additional aspects of the disclosure will be set forth in part in the description which follows and, in part, will be obvious from the description, or may be learned by practice of the disclosure.

### Technical Solution

One aspect of the present disclosure provides an electrophoretic display apparatus to display images including: a common electrode supplied with a common voltage; a pixel electrode arranged to correspond to the common electrode; a plurality of color pigments disposed between the common electrode and the pixel electrode and dispersed in a solvent; a data driver configured to supply a data voltage of a frame, among data voltages of frames, of an image among the images, to the pixel electrode; a voltage compensator configured to compensate for a driving voltage supplied to the data driver; a first sensor portion configured to repeatedly detect a first detection data comprising at least one of a first current and a first voltage on a power side of the data driver; a second sensor portion configured to repeatedly detect a second detection data including at least one of a second current and a second voltage of the common electrode; a memory configured to accumulatively store the first detection data repeatedly detected in correspondence with the second detection data repeatedly detected as an accumulated first detected data and an accumulated second detection data; and a controller configured to control the voltage compensator to compensate for the driving voltage supplied to the data driver by supplying a compensation voltage based on the accumulated first detection data and the accumulated second detection data to the data driver to allow at least one of the first detection data and the second detection data to reach a set reference data.

Another aspect of the present disclosure provides a method of controlling of an electrophoretic display apparatus to display images including: supplying a common voltage to a common electrode; supplying a driving voltage to a data driver configured to supply a data voltage of a frame, among data voltages of frames, of an image among the images, to a pixel electrode; supplying the data voltage to the pixel electrode; repeatedly detecting a first detection data including at least one of a first current and a first voltage on a power side of the data driver; repeatedly detecting a second detection data including at least one of a second current and a second voltage of the common electrode; accumulatively storing the first detection data repeatedly detected as an accumulated first detection data in correspondence with the second detection data repeatedly detected as an accumulated second detection data; and compensating for a driving voltage supplied to the data driver by supplying a compensation voltage based on the accumulated first detection data and the accumulated second detection data to allow at least one of the first detection data and the second detection data to reach a set reference data.

### DESCRIPTION OF DRAWINGS

FIG. 1 is a configuration diagram of an electrophoretic display apparatus according to one embodiment.

FIG. 2 illustrates pixels of the electrophoretic display apparatus according to one embodiment.

FIG. 3 is a control block diagram of the electrophoretic display apparatus according to one embodiment.

FIG. 4 illustrates a waveform of a data voltage supplied from a data driver to a pixel electrode in the electrophoretic display apparatus according to one embodiment.

FIG. 5 illustrates a voltage level and charging/discharging sequence of waveform of the data voltage supplied to the pixel electrode from the data driver of the electrophoretic display apparatus according to one embodiment.

FIG. 6 is a configuration diagram of a voltage compensator of a power supply portion of the electrophoretic display apparatus according to one embodiment.

FIG. 7 is a circuit diagram of the voltage compensator of the electrophoretic display apparatus according to one embodiment.

FIG. 8 is a circuit diagram of a stabilization circuit of the electrophoretic display apparatus according to one embodiment.

FIG. 9 is an example of a flowchart of a method of controlling the electrophoretic display apparatus according to one embodiment.

FIG. 10 illustrates a section for detecting changes in electrical characteristics during charging/discharging of a capacitive load in the electrophoretic display apparatus according to one embodiment.

FIG. 11 illustrates compensation of a driving voltage supplied to the data driver in the electrophoretic display apparatus according to one embodiment.

### MODES OF THE INVENTION

Embodiments described in the disclosure and configurations shown in the drawings are merely examples of the embodiments of the disclosure, and may be modified in various different ways at the time of filing of the present application to replace the embodiments and drawings of the disclosure.

In addition, the same reference numerals or signs shown in the drawings of the disclosure indicate elements or components performing substantially the same function.

A singular expression may include a plural expression unless otherwise indicated herein or clearly contradicted by context.

The expressions “A or B,” “at least one of A or/and B,” or “one or more of A or/and B,” “A, B or C,” “at least one of A, B or/and C,” or “one or more of A, B or/and C,” and the like used herein may include any and all combinations of one or more of the associated listed items.

Terms such as “portion”, “module”, and “member” may be embodied as hardware or software. According to embodiments, a plurality of “portion”, “module”, and “member” may be implemented as a single component or a single “portion”, “module”, and “member” may include a plurality of components.

Also, the terms used herein are used to describe the embodiments and are not intended to limit and/or restrict the disclosure. The singular forms “a,” “an” and “the” are intended to include the plural forms as well, unless the context clearly indicates otherwise. In this disclosure, the terms “including”, “having”, and the like are used to specify features, numbers, steps, operations, elements, components, or combinations thereof, but do not preclude the presence or addition of one or more of the features, numbers, steps, operations, elements, components, or combinations thereof.

It will be understood that, although the terms first, second, third, etc., may be used herein to describe various elements, but elements are not limited by these terms. These terms are only used to distinguish one element from another element. For example, without departing from the scope of the disclosure, a first element may be termed as a second element, and a second element may be termed as a first element. The term of “and/or” includes a plurality of combinations of relevant items or any one item among a plurality of relevant items.

When an element (e.g., a first element) is referred to as being “(functionally or communicatively) coupled,” or “connected” to another element (e.g., a second element), the first element may be connected to the second element, directly (e.g., wired), wirelessly, or through a third element.

When an element is said to be “connected”, “coupled”, “supported” or “contacted” with another element, this includes not only when elements are directly connected, coupled, supported or contacted, but also when elements are indirectly connected, coupled, supported or contacted through a third element.

Throughout the description, when an element is “on” another element, this includes not only when the element is in contact with the other element, but also when there is another element between the two elements.

Meanwhile, the terms “up and down direction”, “front and rear direction”, and the like used in the following description are defined based on the drawings, and the shape and position of each component are not limited by these terms. For example, the terms “front” and “rear” below may be defined based on a X direction shown in the drawings, respectively. The terms “upper” and “lower” below may be defined based on a Z direction shown in the drawings, respectively. The terms “left direction” and “right direction” below may be defined based on a Y direction shown in the drawings, respectively. The term “vertical direction” below may mean a Z direction shown in the drawings, respectively, and the term “horizontal direction” below may mean the Y direction shown in the drawings, respectively.

Hereinafter exemplary embodiments of the present disclosure will be described in detail with reference to the accompanying drawings.

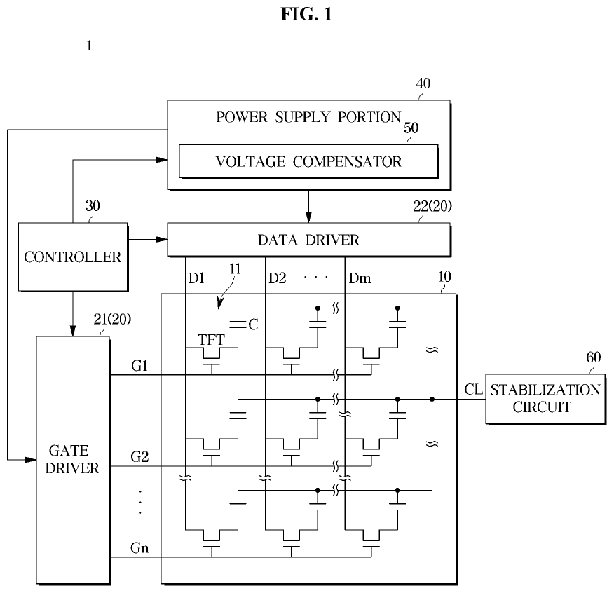

FIG. 1 is a configuration diagram of an electrophoretic display apparatus according to one embodiment.

Referring to FIG. 1, an electrophoretic display apparatus 1 is a device capable of visually displaying characters or images. The following illustrates an example in which the electrophoretic display apparatus 1 is electronic paper, but is not limited thereto. The display apparatus 1 is not limited in form as long as the device is a device configured to visually display images.

The electrophoretic display apparatus 1 may include a display panel 10, a panel display driver IC (Panel Display Driver Integrated Circuit (PDDI)) 20, a controller 30, and a power supply portion 40.

The display panel 10 may include m×n pixels 11.

The display panel 10 may be formed to allow a plurality of data lines D1 to Dm to intersect with a plurality of gate lines G1 to Gn. A thin film transistor (TFT) may be electrically connected to each pixel 11 in an intersecting area.

The panel driver 20 may transmit electrical signals to each pixel 11 in an accurate time and order under the control of the controller 30.

The controller 30 may receive a control signal from a central processing unit (AP or CPU) of the electrophoretic display apparatus 1. The controller 30 may include a memory, a processor, and a control circuit board on which the memory and the processor are mounted.

The controller 30 may generate a driver control signal (gate control signal and data control signal) for controlling the panel driver 20 based on the provided control signal, and provide the driver control signal to the panel driver 20.

The power supply portion 40 may supply power to the display panel 10, the panel driver 20, and the controller 30.

When power is supplied to the electrophoretic display apparatus 1, the power supply portion 40 may generate voltages necessary for driving the display panel 10 using the input power. The power supply portion 40 may generate driving voltages according to a power control signal provided from the controller 30.

The power supply portion 40 may supply a driving voltage to the panel driver 20. For example, the power supply portion 40 may generate a plurality of driving voltages for applying an electric field to the charged color pigments of the pixels 11 of the display panel 10, and supply the voltages to the panel driver 20 to output a waveform for determining positions of the charged color pigments.

The panel driver 20 may include a gate driver 21 and a data driver 22.

The gate driver 21 may supply a gate voltage to the plurality of gate lines G1 to Gn of the display panel 10 according to a gate control signal provided from the controller 30. The gate driver 21 may select a TFT of the corresponding line and turn on or off the TFT.

When the gate driver 21 applies a gate voltage to the gate line G1 to Gn, the TFT may be turned on or off by the applied gate voltage, and thus the pixel 11 of the corresponding line may be driven.

The data driver 22 may supply a waveform to the plurality of data lines D1 to Dm of the display panel 10 according to a data control signal provided from the controller 30.

The electrophoretic display apparatus 1 may supply a waveform to a specific pixel 11 using the gate driver 21 and the data driver 22. The waveform may be generated in various versions by reflecting characteristics of the charged color pigment and solvent of the pixel 11, characteristics of a unique manufacturing process of a solvent manufacturer, and an operating temperature. For example, control information for implementing a waveform for displaying white, blue, red, yellow, and the like on the pixel 11 may be stored in advance.

The controller 30 may provide the control information for implementing a waveform to the gate driver 21 and the data driver 22. The controller 30 may generate a waveform implemented as a sequence of positive (+) and negative (−) voltages in a series of reset sections and writing sections in order to move a charged color pigment to a desired position.

The data driver 22 may generate a waveform using waveform control information from the controller 30 and a driving voltage supplied from the power supply portion 40, and supply the generated waveform to the plurality of data lines D1 to Dm.

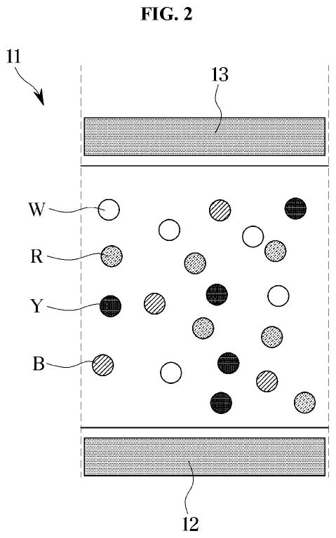

FIG. 2 illustrates pixels of the electrophoretic display apparatus according to one embodiment.

Referring to FIG. 2, the display panel 10 may include a pixel electrode 12 disposed on a lower substrate and a common electrode 13 disposed on an upper substrate.

The pixel electrode 12 and the common electrode 13 may be arranged to face each other.

The common electrode 13 disposed on the upper substrate may be provided as a transparent electrode layer to be placed on a lateral side to be visible to a user.

A series of electric fields may be formed on the pixel 11 by a potential difference between a common voltage of the common electrode 13 and a waveform of the pixel electrode 12. The electric field may guide color pigments arranged between the common electrode 13 and the pixel electrode 12 to a desired position, thereby implementing a desired color by utilizing external light reflection.

Color pigments charged with a preset electrostatic capacitance may be dispersed in a solvent to form an electrophoretic layer between the common electrode 13 and the pixel electrode 12.

The color pigments of the electrophoretic layer may be charged with positive (+) or negative (−) charges of different polarities and capacities. When a waveform is applied through the data driver 22, the color pigments may move due to the electric field difference with respect to the common electrode 13, and a desired color may be implemented by utilizing external light reflection.

For example, a plurality of color pigments may include four color particles W, B, R, and Y.

The four-color particles W, B, R and Y may include two pairs of particles with opposite charge polarity.

A first pair may include a white particle W and a blue particle B. The white particle W may have a high positive (+) charge, and the blue particle B may have a high negative (−) charge.

A second pair may include a red particle R and a yellow particle Y. The red particle R may have a low positive (+) charge, and the yellow particle Y may have a low negative (−) charge.

According to various embodiments, the white particle W, the blue particle B, the red particle R, and the yellow particle Y may have various shapes.

The four-color particles W, B, R, and Y may be mixed to adjust the color state. The four colors W, B, R, and Y may be expanded to other colors in addition to white, blue, red, and yellow.

For example, when a high negative (−) potential is applied to the pixel electrode 12 compared to the common voltage of the common electrode 13, a high electric field is generated, the blue particle B with a negative (−) charge moves toward the common electrode 13, and the white particle W with a high positive (+) charge moves toward the pixel electrode 12. Because the red particle R and yellow particle Y have a small capacitance, a force, which is less than that of the white particle W with a high positive (+) charge and the blue particle B with a high negative (−) charge, is applied to the red particle R and yellow particle Y in the same electric field and thus moving distances of the red particle R and yellow particle Y to the common electrode 13 is shorter compared to the time. Finally, the movement of the blue particle B is concentrated toward the common electrode 13 for a certain period of time, and the blue particle B is displayed as blue to a user through external light reflection.

In addition, when a high positive (+) potential is applied to the pixel electrode 12 compared to the common voltage of the common electrode 13, a high electric field of the opposite polarity is generated, and thus particle distribution appears opposite to the previous one. Finally, it appears white to a user through external light reflection.

Further, when a low positive (+) potential is applied to the pixel electrode 12 compared to the common voltage of the common electrode 13, a low electric field is applied to the blue particle B with a high negative (−) charge, and movement thereof toward the pixel electrode 12 is restricted. The white particle W with a high positive (+) charge is also restricted from moving toward the common electrode 13 for the same reason. This is because the low electric field is not strong enough to overcome the strong attraction between the two particles. On the other hand, the low electric field is sufficient to separate the yellow particle Y with a low negative (−) charge and the red particle R with a low positive (+) charge. Accordingly, the red particle R with a low positive (+) charge moves toward the common electrode 13 and the yellow particle Y with a low negative (−) charge moves toward the pixel electrode 12. Finally, it appears red to a user through external light reflection.

Additionally, when a low negative (−) potential is applied compared to the common voltage of the common electrode 13, a low electric field of the opposite polarity is generated, and thus the particle distribution appears opposite to the previous one. Finally, it appears yellow to a user through external light reflection.

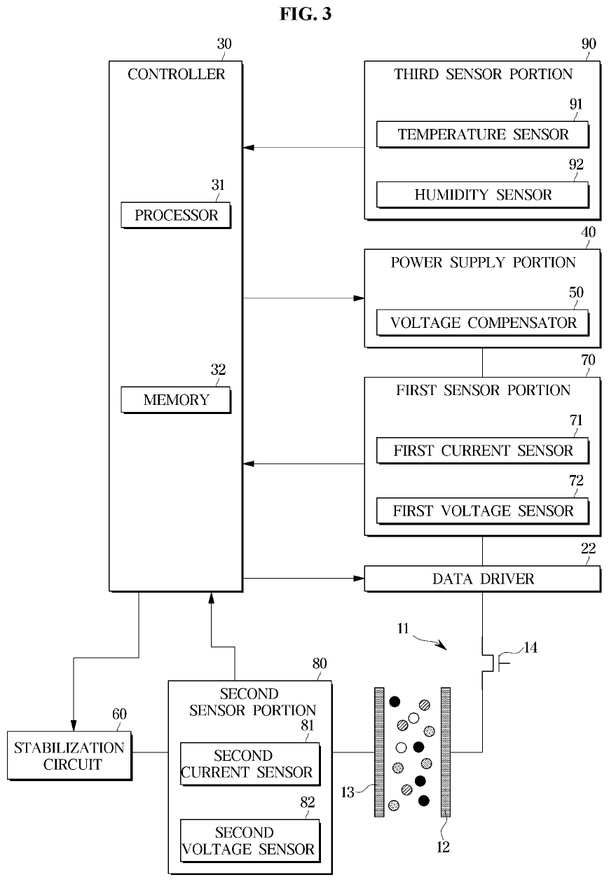

FIG. 3 is a control block diagram of the electrophoretic display apparatus according to one embodiment.

Referring to FIG. 3, the power supply portion 40 may supply a driving voltage to the data driver 22.

The data driver 22 may be electrically connected to a source electrode of the TFT 14 through a data line.

A drain electrode of the TFT 14 may be electrically connected to the pixel electrode 12.

According to various embodiments, the source electrode of the TFT 14 may be electrically connected to the pixel electrode 12, and the drain electrode of the TFT 14 may be electrically connected to the data driver 22.

A gate electrode of the TFT 14 may be electrically connected to the gate driver 21.

The TFT 14 may be turned on or off by a gate voltage output from the gate driver 21. By using a driving voltage supplied from the power supply portion 40, the data driver 22 may generate a data voltage having a waveform.

In a state in which the TFT 14 is turned on, the data voltage output from the data driver 22 may be supplied to the pixel electrode 12 through the TFT 14.

A common voltage (Vcom) may be supplied to the common electrode 12. The common voltage may be a DC voltage or an AC voltage. The common electrode 12 may receive the common voltage from the power supply portion 40.

Therefore, an electric field may be formed in the pixel 11 by the potential difference between the data voltage of the pixel electrode 12 and the common voltage of the common electrode 13.

A capacitive load may be formed between the common electrode 13 and the source electrode of the TFT 14 in the pixel 11. According to various embodiments, the capacitive load may be formed between the common electrode 13 and the pixel electrode 12.

In order to arrange the plurality of color pigments of the pixel 11 to a specific position for the reproducibility or move the plurality of color pigments to an initial position, it is required to switch a high positive (+) or negative (−) voltage (for example, +20 V or −20 V) symmetrical to the common voltage of the common electrode 13 at high speed (for example, 85 Hz). In addition, depending on the characteristics or environment of the pixel 11, it may be driven at high speed for a short period of several seconds (for example, 15 seconds) to several minutes. At this time, it is required to stably supply and recover several pulsed charging/discharging currents (sourcing current/sinking current) of positive and negative amperes (for example, 2.5 A) generated when a high positive or negative voltage is switched.

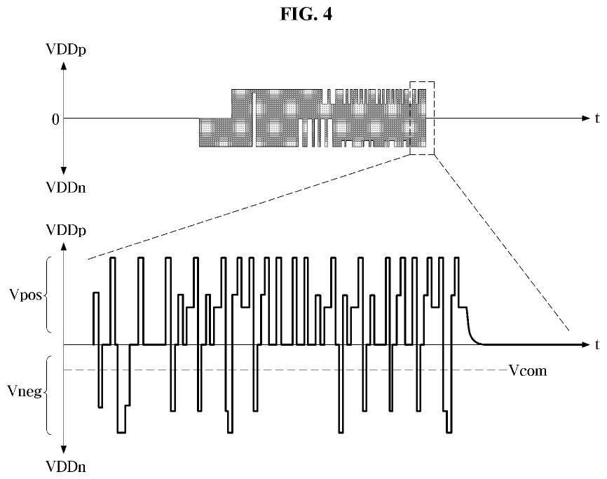

FIG. 4 illustrates a waveform of a data voltage supplied from a data driver to a pixel electrode in the electrophoretic display apparatus according to one embodiment.

Referring to FIG. 4, in order to move a desired color pigment among the plurality of color pigments to the common electrode 13, the color pigments located on the common electrode 13 is required to be quickly moved to a neutral position or an initial position. For this, a positive and negative data voltage having a high voltage is required to be applied while inverting between positive (+) and negative (−) voltages continuously for a long time, which is called a reset section. Thereafter, in order to move a specific charged color pigment to be expressed to the common electrode 13, a waveform of a data voltage corresponding to a preset charge amount is required to be applied to the pixel electrode 12, which is called a writing section.

An output of the data driver 22 is transmitted to the pixel electrode 12 via the TFT 14. When a potential difference occurs between the data voltage of the pixel electrode 12 and the common voltage of the common electrode 13, an electric field is formed in the color pigments between the pixel electrode 12 and the common electrode 13, and thus the color pigments are moved.

When a positive and negative data voltage is applied to the pixel electrode 12 in the reset section and/or the write section, an electric field applied to the color pigments disposed between the pixel electrode 12 and the common electrode 13 may be changed. Accordingly, a rapid charging/discharging operation occurs in the capacitive load according to the potential difference relationship between the common electrode 13 and the pixel electrode 12, and a current change occurs due to the movement of electric charges.

The data driver 22 may generate a data voltage supplied to the pixel electrode 12 using the driving voltages generated by the power supply portion 40. The data voltage may be repeated based on the common voltage within a range of positive (+) voltage (for example, +19 V) and negative (−) voltage (for example, −19 V) to move the charged color pigment to the common electrode 13, and may have multiple voltage levels depending on the charge amount of the charged color pigments. The positive (+) voltage (Vpos) of the data voltage may have multiple voltage levels. The negative (−) voltage (Vneg) of the data voltage may have multiple voltage levels.

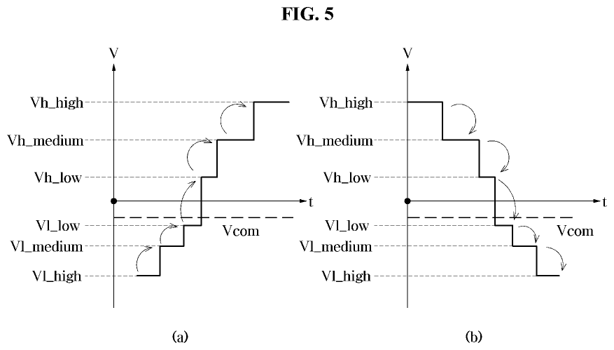

FIG. 5 illustrates a voltage level and charging/discharging sequence of waveform of the data voltage supplied to the pixel electrode from the data driver of the electrophoretic display apparatus according to one embodiment.

Referring to FIG. 5, the data voltage may have a waveform that rises in steps and falls in steps.

For example, the voltage levels of the waveform of the data voltage may include six voltage levels: Vh_high, Vh_medium, Vh_low, Vl_low, Vl_medium, and Vl_high. Vh_high, Vh_medium, and Vh-low may be positive (+) voltages. At this time, a sequence of Vh_high, Vh_medium, and Vh_low may represent a descending order of voltage values (Vh_high>Vh_medium>Vh_low). In addition, Vl_low, Vl_medium, and Vl_high may be negative (−) voltages. At this time, a sequence of Vl_low, Vl_medium, and Vl_high may represent a descending order of voltage values (Vl_low>Vl_medium>Vl_high).

As illustrated in (a) of FIG. 5, the waveform of the data voltage may include a rising pattern in which a voltage value rises from Vh_low to Vh_medium and a rising pattern in which a voltage value rises from Vh_medium to Vh_high even within the positive (+) voltage (Vpos). The waveform of the data voltage may also include a rising pattern in which a voltage value rises from Vl_high to Vl_medium and a rising pattern in which a voltage value rises from Vl_medium to Vl_low even within the negative (−) voltage (Vneg).

As illustrated in (b) of FIG. 5, the waveform of the data voltage may include a falling pattern in which a voltage value falls from Vh_high to Vh_medium, and a falling pattern in which the voltage value falls from Vh_medium to Vh_low within the positive (+) voltage (Vpos). The waveform of the data voltage may also include a falling pattern in which a voltage value falls from Vl_low to Vl_medium, and a falling pattern in which a voltage value falls from Vl_medium to Vl_high within the negative (−) voltage (Vneg).

In addition, the waveform of the data voltage may include various rising patterns, such as a rising pattern in which the voltage value rises from Vh_low to Vh_high, a rising pattern in which the voltage value rises from Vl_high to Vl_low, and a rising pattern in which the voltage value rises from Vl_high to Vh_high. The waveform of the data voltage may include various falling patterns, such as a falling pattern in which the voltage value falls from Vh_high to Vh_low, a falling pattern in which the voltage value falls from Vl_low to Vl_high, and a falling pattern in which the voltage value falls from Vh_high to Vl_high.

Referring again to FIG. 3, the power supply portion 40 may generate a driving voltage of multiple voltage levels using input power, and supply the driving voltage of multiple voltage levels to the data driver 22.

The data driver 22 may generate a data voltage having a waveform composed of a series of voltage waveforms using the driving voltage supplied from the power supply portion 40, and supply the data voltage to the pixel electrode 12 of the pixel 11. The data voltage may include a waveform in which a high voltage having positive (+) polarity and a high voltage having negative (−) polarity alternate. The positive (+) voltage and the negative (−) voltage of the data voltage may each have multiple voltage levels. Accordingly, the voltage level of the driving voltage supplied from the power supply portion 40 to the data driver 22 may also have multiple voltage levels.

For example, the driving voltage of the multi voltage levels may include six voltage levels: Vh_high, Vh_medium, Vh_low, Vl_low, Vl_medium, and Vl_high, similar to the voltage levels of the waveform of the data voltage.

In general, the movement of color pigments changes when stored and operated above or below a certain temperature and over a certain period of time. The amount of charge charged to the color pigment or the chemical bonding properties of the pigment and solvent decrease or change depending on the operating environment such as temperature, humidity, and electrical stress. As a result, even when an electric field, which is initially set, is applied, the operating characteristics of the color pigment change, and thus it is difficult for the color pigment to move to the set position.

As mentioned above, changes in the charge amount of pigments, changes in the characteristics of solvents, and changes in the characteristics of TFTs occur due to high/low temperature environments or long-term operation. These characteristic changes may vary for each display panel production lot and in severe cases, may be different for each panel. Accordingly, it is difficult to determine a time and voltage for an optimal operation. In addition, when it is difficult to change a voltage (electric field) applied to opposite ends of the color pigment, an operation that applies a voltage (electric field) for a long time is required. As a result, a sense of discomfort occurs due to flickering during operation, and electrical stress increases. Accordingly, characteristic changes are accelerated and power consumption also increases.

Even when the electrical characteristics, such as color pigments, solvents, and switching elements of the display panel 10, change due to electrical stress caused by high/low temperature and high humidity environments or long-term operation, the electrophoretic display apparatus 1 according to one embodiment may compensate for the voltage supplied to the data driver 22, thereby complementing afterimages and color changes caused by changes in electrical characteristics, suppressing increases in power consumption, and improving product life and reliability.

The electrophoretic display apparatus 1 according to one embodiment may include a first sensor portion 70 and a second sensor portion 80.

The first sensor portion 70 may be disposed between the power supply portion 40 and the data driver 22.

The first sensor portion 70 may detect a current and/or voltage between the power supply portion 40 and the data driver 22. The first sensor portion 70 may detect a current and/or voltage on a power side of the data driver 22 connected to an output side of the power supply portion 40. The first sensor portion 70 may be provided to correspond to a voltage compensator 50. For example, when a plurality of voltage compensators 50 is provided, a plurality of first sensor portions 70 may be also provided. When six voltage compensators 50 are provided, six first sensor portions 70 may be also provided.

The first sensor portion 70 may include a first current sensor 71 and/or a first voltage sensor 72.

The first current sensor 71 may detect a current on the power side of the data driver 22. The first voltage sensor 72 may detect a voltage on the power side of the data driver 22. For example, the first current sensor 71 may include a current transformer (CT), a shunt resistor, a hall sensor, and the like.

The second sensor portion 80 may be disposed between the common electrode 13 and a stabilization circuit 60. The stabilization circuit 60 may be a circuit for stabilizing a potential of the common electrode 13.

The second sensor portion 80 may detect a current and/or voltage of the common electrode 13.

The second sensor portion 80 may include a second current sensor 81 and/or a second voltage sensor 82.

The second current sensor 81 may detect the current of the common electrode 13. The second voltage sensor 82 may detect the voltage of the common electrode 13.

The controller 30 may include a processor 31 and a memory 32. The processor 31 may be hardware and include a logic circuit and an arithmetic circuit. The processor 31 may control electrically connected components of the electrophoretic display apparatus 1 using a program, instructions and/or data stored in the memory 32 for the operation of the electrophoretic display apparatus 1. The processor 31 and the memory 32 may be implemented as separate chips or as a single chip. In addition, the controller 30 may include a plurality of processors and a plurality of memories.

The memory 32 may store programs, applications, and/or data for the operation of the electrophoretic display apparatus 1, and may store data generated by the processor 31. The memory 32 may include non-volatile memory such as Read Only Memory (ROM) and flash memory for storing data for a long period of time. The memory 32 may include volatile memory such as Static Random Access Memory (S-RAM) and Dynamic Random Access Memory (D-RAM) for temporarily storing data.

The controller 30 may receive a first current data on the power side of the data driver 22 detected by the first current sensor 71. The controller 30 may receive a first voltage data on the power side of the data driver 22 detected by the first voltage sensor 72.

The controller 30 may receive a second current data of the common electrode 13 detected by the second current sensor 81.

The controller 30 may receive a second voltage data of the common electrode 13 detected by the second voltage sensor 82.

In addition, the electrophoretic display apparatus 1 according to one embodiment may further include a third sensor portion 90 configured to detect environmental information.

The third sensor portion 90 may include a temperature sensor 91 and/or a humidity sensor 92. The third sensor portion 90 may include an environmental sensor configured to detect various types of environmental data in addition to temperature and humidity.

The temperature sensor 91 may detect a temperature of the electrophoretic display apparatus 1 or the display panel 10. For example, the temperature sensor 91 may detect a temperature of a periphery of the electrophoretic display apparatus 1 or the display panel.

The humidity sensor 92 may detect a humidity of the electrophoretic display apparatus 1 or the display panel 10. For example, the humidity sensor 92 may detect a humidity of the data driver 22.

The controller 30 may receive temperature data of the periphery of the electrophoretic display apparatus 1 or the display panel by the temperature sensor 91. The controller 30 may receive a humidity data of the data driver 22 detected by the humidity sensor 92.

According to one embodiment, the controller 30 may compensate for a voltage supplied from the power supply portion 40 to the data driver 22 through the voltage compensator 50 based on the first current data detected by the first current sensor 71, the first voltage data detected by the first voltage sensor 72, the second current data detected by the second current sensor 81, and the second voltage data detected by the second voltage sensor 82. For example, the controller 30 may store the first current data, the first voltage data, the second current data, and the second voltage data, and determine a compensation voltage based on the first current data, the first voltage data, the second current data, and the second voltage data. Alternatively, the controller 30 may accumulate the first current data, the first voltage data, the second current data, and the second voltage data over time and analyze the accumulated data using a statistical method so as to determine a compensation voltage. Accordingly, the controller 30 may compensate for the voltage supplied to the data driver 22 through the voltage compensator 50 as much as the compensation voltage.

According to various embodiments, the controller 30 may compensate for a voltage supplied to the data driver 22 through the voltage compensator 50 based on the first current data detected by the first current sensor 71 and the second current data detected by the second current sensor 81.

According to various embodiments, the controller 30 may compensate for a voltage supplied to the data driver 22 through the voltage compensator 50 based on the first voltage data detected by the first voltage sensor 72 and the second voltage data detected by the second voltage sensor 82.

According to various embodiments, the controller 30 may compensate for a voltage supplied to the data driver 22 through the voltage compensator 50 based on the first current data detected by the first current sensor 71, the first voltage data detected by the first voltage sensor 72, the second current data detected by the second current sensor 81, the second voltage data detected by the second voltage sensor 82, the temperature data detected by the temperature sensor 91, and the humidity data detected by the humidity sensor 92. For example, the controller 30 may store the first current data, the first voltage data, the second current data, the second voltage data, the temperature data, and the humidity data, and determine a compensation voltage based on the first current data, the first voltage data, the second current data, the second voltage data, the temperature data, and the humidity data. Alternatively, the controller 30 may accumulate the first current data, the first voltage data, the second current data, the second voltage data, the temperature data, and the humidity data over time, and analyze the accumulated data using a statistical method so as to determine a compensation voltage. Accordingly, the controller 30 may compensate for the voltage supplied to the data driver 22 through the voltage compensator 50 as much as the compensation voltage.

Accordingly, the electrophoretic display apparatus 1 according to one embodiment may detect a change in electrical characteristics of the pixel 11 and based on this, apply an additional positive and negative voltage higher or lower than the normal driving voltage to compensate for particle movement characteristics, thereby minimizing an increase in driving time due to a change in characteristics of the pixel 11 and suppressing discomfort, afterimages, color changes, and increased power consumption.

In addition, the controller 30 may compensate for the driving voltage before the driving section (reset section and write section) starts. For example, the controller 30 may apply the compensation voltage to the driving voltage during a power booting stage. This may allow a stable operation from the start of driving by setting the necessary voltage compensation in advance before the system starts full-scale driving. That is, by applying the compensation voltage in advance during a system booting stage after the power is turned on, the voltage compensation may be completed before the start of the main driving section.

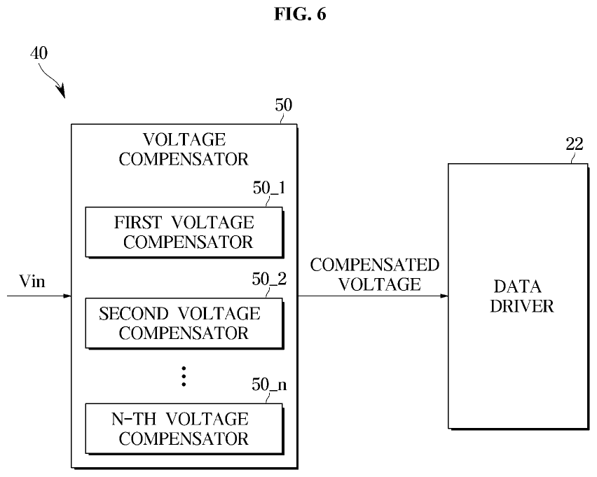

FIG. 6 is a configuration diagram of a voltage compensator of a power supply portion of the electrophoretic display apparatus according to one embodiment.

Referring to FIG. 6, the power supply portion 40 may generate a plurality of positive and negative driving voltages using input power (Vin) and supply the plurality of positive and negative driving voltages to the data driver 22.

The power supply portion 40 may include the voltage compensator 50 configured to compensate for the voltage supplied to the data driver 22.

The voltage compensator 50 may compensate for a voltage supplied to the data driver 22 under the control of the controller 30. In various embodiments, the voltage compensator 50 may be embedded in the panel driver 20. For example, the voltage compensator 50 may be embedded in the data driver 22.

The voltage compensator 50 may be electrically connected to the data driver 22.

The voltage compensator 50 may output a compensation voltage with a compensated voltage level to the data driver 22.

The voltage compensator 50 may include a first voltage compensator 50_1 to an n-th voltage compensator 50_n. The first voltage compensator 50_1 may output a first compensation voltage that compensates for a driving voltage of a first voltage level to the data driver 22. The second voltage compensator 50_2 may output a second compensation voltage that compensates for a driving voltage of a second voltage level to the data driver 22. The n-th voltage compensator 50_n may output an n-th compensation voltage that compensates for a driving voltage of an n-th voltage level to the data driver 22.

For example, the voltage compensator 50 may compensate for at least one of the six voltage levels of Vh_high, Vh_medium, Vh_low, Vl_low, Vl_medium, and Vl_high to the data driver 22, and output a compensation voltage with the compensated voltage level to the data driver 22.

In addition, the voltage compensator 50 may supply a charging current to the capacitive load through the data driver 22 when charging the capacitive load of the pixel 11, and may absorb a discharging current entering the data driver 22 when discharging the capacitive load.

The voltage compensator 50 may perform a sourcing operation that supplies a charging current to the capacitive load when charging the capacitive load or a sinking operation that absorbs a discharging current from the capacitive load when discharging the capacitive load.

The voltage compensator 50 may generate the charging current supplied from the voltage compensator 50 to the data driver 22 through the sourcing operation when charging the capacitive load, and may supply the generated charging current to the capacitive load through the data driver 22.

The voltage compensator 50 may absorb the discharging current flowing from the capacitive load to the voltage compensator 50 through the data driver 22 through the sinking operation when discharging the capacitive load.

By automatically performing the sourcing operation when charging the capacitive load and the sinking operation when discharging the capacitive load, the voltage compensator 50 may stably supply a peak charging/discharging current in the positive and negative directions that occurs when charging/discharging the capacitive load.

The capacitive load may repeat charging and discharging operations as the data voltage supplied to the pixel electrode 12 varies for each frame.

The voltage compensator 50 may perform the sourcing operation that supplies a charging current to the data driver 22 or the sinking operation that absorbs a discharging current flowing from the data driver 22 based on a difference between a data voltage of a current frame and a data voltage of a previous frame.

The voltage compensator 50 may perform the sourcing operation in response to the data voltage of the current frame being higher than the data voltage of the previous frame.

The voltage compensator 50 may perform the sinking operation in response to the data voltage of the current frame being lower than the data voltage of the previous frame.

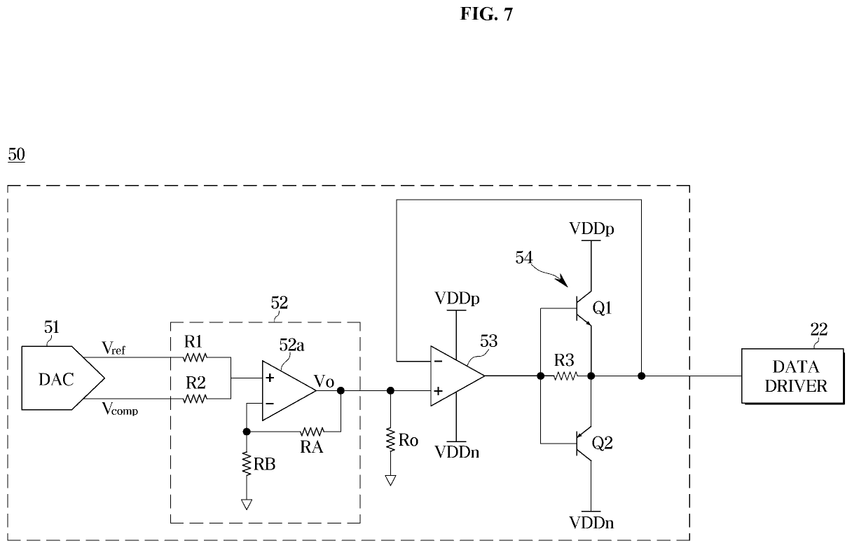

FIG. 7 is a circuit diagram of the voltage compensator of the electrophoretic display apparatus according to one embodiment.

Referring to FIG. 7, as an example of a simple configuration of the voltage compensator 50, the voltage compensator 50 may include a digital-to-analog converter (DAC) 51, a voltage adder 52, an operational amplifier 53, and a current amplifier 54.

The digital-to-analog converter (DAC) 51 may receive a digital driving voltage and compensation voltage, convert the digital driving voltage and compensation voltage into an initially set analog driving voltage (Vref) and analog compensation voltage (Vcomp), and output the analog driving voltage (Vref) and the analog compensation voltage (Vcomp). The digital driving voltage may be a data voltage supplied to the data driver 22 in an initial state or before a state change occurs. The digital compensation voltage may be a voltage supplied under the control of the controller 30 when compensation of the driving voltage is required. When there is no digital compensation voltage, the digital-to-analog converter (DAC) 51 may convert only the digital driving voltage and output only the analog driving voltage (Vref).

As an example of a simple configuration of the voltage adder 52, the voltage adder 52 is a circuit in which two input voltages (Vref and Vcomp) are connected to an inverting input terminal (−) of an operational amplifier 52a through respective input resistors R1 and R2, a non-inverting input terminal (+) is grounded through a resistor RB, and a feedback resistor RA is connected between an output terminal and the inverting input terminal (−).

The voltage adder 52 may receive the driving voltage (Vref) and the compensation voltage (Vcomp) from the digital-to-analog converter 51, add the driving voltage (Vref) and the compensation voltage (Vcomp) to generate a compensated voltage (Vref+Vcomp), and output the compensated voltage (Vref+Vcomp=Vo). For example, when the driving voltage (Vref) is +19 V and the driving voltage (Vref) needs to be increased from +19 V to +21 V, instead of generating a new voltage of +21 V, the compensated voltage may be generated as +21 V by adding +2 V to the driving voltage (Vref) of +19 V.

According to various embodiments, the summation of the driving voltage (Vref) and the compensation voltage (Vcomp) may be implemented in various ways, instead of using the digital-to-analog converter 51 and the voltage adder 52. For example, it is also possible to sum up the two voltages using a charge pump. The voltage summation method is not limited to a specific circuit configuration and may be implemented in various forms.

A positive (+) voltage (VDDp) and a negative (−) voltage (VDDn) of the operational amplifier 53 may include a voltage range equal to or greater than a variable range of voltage from the voltage adder 52.

The operational amplifier 53 may include an OP-AMP. The compensated voltage (Vref+Vcomp) input from the voltage adder 52 may be supplied to the non-inverting input terminal (+) of the operational amplifier 53, and a voltage of an output node of the current amplifier 54 may be fed back and supplied to the inverting input terminal (−).

The output terminal of the operational amplifier 53 may be connected to an input node of the current amplifier 54.

The operational amplifier 53 may supply a sinking current or a sourcing current that is required to drive the current amplifier 54.

The operational amplifier 53 may output a current by comparing the feedback voltage of the non-inverting input terminal (+) and the inverting input terminal (−).

The current amplifier 54 may include a first switching element Q1, a second switching element Q2 connected to the first switching element Q1, and a resistor R3 connected to the first switching element Q1 and the second switching element Q2.

The first switching element Q1 may be an NPN transistor as a switching element, and the second switching element Q2 may be a PNP transistor as a switching element.

In the first switching element Q1, a collector may be connected to the positive (+) voltage (VDDp) and an emitter may be connected to the output node.

In the second switching element Q2, a collector may be connected to the negative (−) voltage (VDDn) and an emitter may be connected to the output node.

One side of the resistor R3 may be be commonly connected to the output terminal of the operational amplifier 53, and bases of the first switching element Q1 and the second switching element Q2. The other side of the resistor R3 may be commonly connected to the emitters of the first switching element Q1 and the second switching element Q2.

The current amplifier 54 may include a push-pull amplifier.

In the current amplifier 54, the upper first switching element Q1 may be turned on, and the lower second switching element Q2 may be turned off by a current output from the operational amplifier 53 to the current amplifier 54. Therefore, the current amplifier 54 may amplify the current output from the operational amplifier 53 and supply the amplified current to the data driver 22.

In addition, in the current amplifier 54, the upper first switching element Q1 may be turned off, and the lower second switching element Q2 may be turned on by a current flowing from the data driver 22 to the operational amplifier 53. Therefore, the current amplifier 54 may absorb the current flowing from the data driver 22.

A voltage difference may be formed at opposite ends of the resistor R3 by the current passing through the resistor R3 of the current amplifier 54. When the voltage difference is formed at the opposite ends of the resistor R3, base currents of the first switching element Q1 and the second switching element Q2 may be generated or de-generated by the voltage difference, thereby selectively turning on or off the first switching element Q1 and the second switching element Q2. A resistance value of the resistor R3 may be adjusted according to the charging/discharging current of the capacitive load.

When the electrical characteristics of the display panel 10 change, the electrophoretic display apparatus 1 according to one embodiment may compensate for a driving voltage supplied to the data driver 22 through the voltage compensator 50 having the above-described configuration. In addition, the voltage compensator 50 may stably supply a charging current to the data driver 22 when charging the capacitive load, and stably absorb a discharging current flowing from the data driver 22 when discharging the capacitive load.

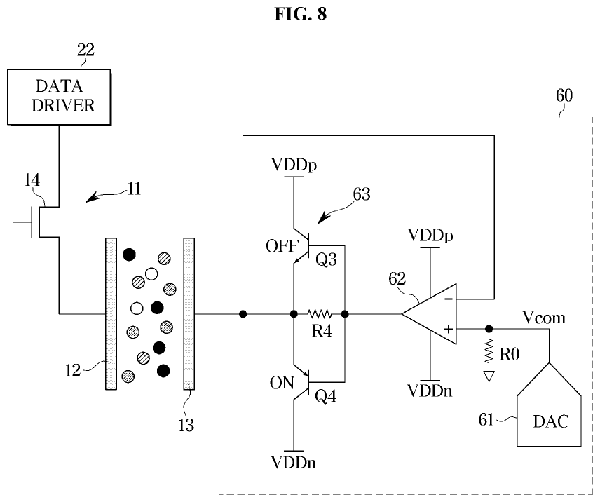

FIG. 8 is a circuit diagram of a stabilization circuit of the electrophoretic display apparatus according to one embodiment.

Referring to FIG. 8, the stabilization circuit 60 may be electrically connected to the common electrode 13 through a common line.

The stabilization circuit 60 may form a stable potential of the common electrode 13 for the data voltage supplied to the pixel electrode 12.

The stabilization circuit 60d may prevent the common voltage (Vcom) from flowing to the pixel electrode 12 by absorbing a current flowing from the common electrode 13 or supplying a current to the common electrode 13 when charging/discharging of the capacitive load of the pixel 11. Accordingly, the stabilization circuit 60 may stabilize the potential of the common electrode 13.

The stabilization circuit 60 may perform the sinking operation that absorbs the current flowing from the capacitive load when charging the capacitive load or the sourcing operation that supplies the current to the capacitive load when discharging the capacitive load.

The stabilization circuit 60 may absorb the current flowing into the common electrode 13 through the sinking operation when charging the capacitive load. The stabilization circuit 60 may supply the current to the common electrode 13 through the sourcing operation when discharging the capacitive load.

The stabilization circuit 60 may stabilize the potential of the common electrode 13 by automatically performing the sinking operation when charging the capacitive load and the sourcing operation when discharging the capacitive load.

The stabilization circuit 60 may perform the sourcing operation that supplies a charging current to the common electrode 13 or the sinking operation that absorbs the current flowing from the common electrode 13 based on the difference between the data voltage of the current frame and the data voltage of the previous frame.

The stabilization circuit 60 may perform the sinking operation in response to the data voltage of the current frame being higher than the data voltage of the previous frame.

The stabilization circuit 60 may perform the sourcing operation in response to the data voltage of the current frame being lower than the data voltage of the previous frame.

The stabilization circuit 60 may include a digital-to-analog converter (DAC) 61, an operational amplifier 62, and a current amplifier 63.

The digital-to-analog converter 61 may receive a digital common voltage, convert the digital common voltage into an analog common voltage (Vcom), and output the analog common voltage (Vcom). The common voltage (Vcom) may be supplied under the control of the controller 30. The common voltage (Vcom) may be an AC voltage or a DC voltage.

The operational amplifier 62 may quickly reflect the voltage change of the common electrode 13. For example, the operational amplifier 62 may quickly reflect the voltage change of the common electrode 13 by receiving the common voltage of the common electrode 13 as feedback.

A positive (+) voltage (VDDp) and a negative (−) voltage (VDDn) applied to the operational amplifier 62 may include a voltage range equal to or greater than a variable range of the common voltage.

The operational amplifier 62 may include an OP-AMP. A common voltage (Vcom) input to the digital-to-analog converter (DAC) 61 may be supplied to a non-inverting input terminal (+) of the operational amplifier 62, and a voltage of an output node of the current amplifier 63 may be fed back and supplied to an inverting input terminal (−).

An output terminal of the operational amplifier 62 may be connected to an input node of the current amplifier 63.

The operational amplifier 62 may supply a sinking current or a sourcing current that is required to drive the current amplifier 63.

The current amplifier 63 may include a third switching element Q3, a fourth switching element Q4 connected to the third switching element Q3, and a resistor R4 connected to the third switching element Q3 and the fourth switching element Q4.

The third switching element Q3 may be an NPN transistor, and the fourth switching element Q4 may be a PNP transistor.

In the third switching element Q3, a collector may be connected to the positive (+) voltage (VDDp) and an emitter may be connected to the output node.

In the fourth switching element Q4, a collector may be connected to the negative (−) voltage (VDDn) and an emitter may be connected to the output node.

One side of the resistor R4 may be commonly connected to the output terminal of the operational amplifier 62, and bases of the third switching element Q3 and the fourth switching element Q4. The other side of the resistor R4 may be commonly connected to the emitters of the third switching element Q3 and the fourth switching element Q4.

The current amplifier 63 may include a push-pull amplifier.

In the current amplifier 63, the upper third switching element Q3 may be turned on and the lower fourth switching element Q4 may be turned off by a current output from the operational amplifier 62 to the current amplifier 63. Therefore, the current amplifier 63 may amplify the current output from the operational amplifier 62 and supply the amplified current to the common electrode 13.

In addition, in the current amplifier 63, the upper third switching element Q3 may be turned off and the lower fourth switching element Q4 may be turned on by a current flowing into the operational amplifier 62 from the common electrode 13. Therefore, the current amplifier 63 may absorb the current flowing from the common electrode 13.

A voltage difference may be formed at opposite ends of the resistor R4 by the current passing through the resistor R4 of the current amplifier 63. When the voltage difference is formed at the opposite ends of the resistor R4, base currents of the third switching element Q3 and the fourth switching element Q4 may be generated or de-generated by the voltage difference, thereby selectively turning on or off the third switching element Q3 and the fourth switching element Q4. A resistance value of the resistor R4 may be adjusted according to the charging/discharging current of the capacitive load.

By using the stabilization circuit 60 having the above-described configuration, the electrophoretic display apparatus 1 according to one embodiment may stably absorb the current flowing from the common electrode 13 when charging the capacitive load, and stably supply the current to the common electrode 13 when discharging the capacitive load.

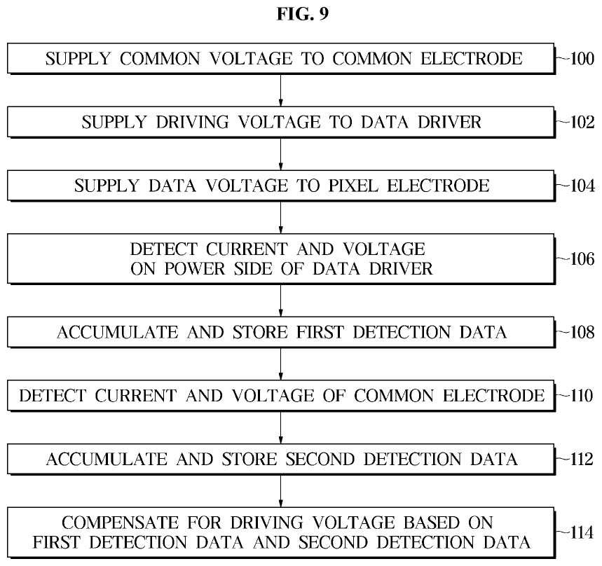

FIG. 9 is an example of a flowchart of a method of controlling of the electrophoretic display apparatus according to one embodiment.

Referring to FIG. 9, the controller 30 may supply a common voltage to the common electrode 13 through the voltage compensator 50 (100).

The controller 30 may supply a driving voltage to the data driver 22 through the voltage compensator 50 (102).

The controller 30 may supply a data voltage in the form of a waveform composed of a series of voltage waveforms to the pixel electrode 12 via the TFT 14 through the data driver 22 (104).

The controller 30 may detect the current and voltage on the power side of the data driver 22 through the first sensor portion 70 during charging/discharging of the capacitive load (106). For example, the controller 30 may receive the first current data on the power side of the data driver 22 detected by the first current sensor 71. The controller 30 may receive the first voltage data on the power side of the data driver 22 detected by the first voltage sensor 72.

The controller 30 may accumulate and store a first detection data including the first current data and the first voltage data detected by the first sensor portion 70 in the memory 31 (108).

The controller 30 may detect the current and voltage of the common electrode 13 through the second sensor portion 80 during charging/discharging of the capacitive load (110). For example, the controller 30 may receive the second current data of the common electrode 13 detected by the second current sensor 81. The controller 30 may receive the second voltage data of the common electrode 13 detected by the second voltage sensor 82.

The controller 30 may accumulate and store a second detection data including the second current data and the second voltage data detected by the second sensor portion 80 in the memory 31 (112). At this time, the controller 30 may accumulate and store the first detection data and the second detection data correspondingly. In addition, the controller 30 may accumulate and store the first detection data, the second detection data, and the detected time data correspondingly.

The controller 30 may compensate for the driving voltage supplied from the voltage compensator 50 to the data driver 22 to allow the first detection data and/or the second detection data to reach preset reference data based on the accumulated first detection data and second detection data. For example, the controller 30 may actively compensate for the driving voltage repeatedly supplied to the data driver 22 by identifying whether the corresponding second detection data corresponding to the corresponding first detection data reaches the preset reference data. For example, in a state in which the driving voltage, which is supplied to the data driver 22 from the voltage compensator 50 when charging the capacitive load, is +15 V, when a current waveform of the common electrode 13 is different from a reference current waveform, which corresponds to preset reference data in the initial state or before the state change occurs, the driving voltage supplied to the data driver 22 from the voltage compensator 50 may be increased from +15 V to +17 V, which is set, so as to compensate for the change in the electrical characteristics of the display panel 10. At this time, the current change may be detected and additionally compensated by comparing the current waveform states at the initial state and before the state change occurs. Accordingly, the current waveform of the common electrode 13 may be matched to the reference current waveform in the initial state or before the state change occurs.

Therefore, the electrophoretic display apparatus 1 according to one embodiment may compensate for the voltage supplied to the data driver 22 even when the electrical characteristics of the color pigments, solvent, and switching elements of the display panel 10 change due to a high/low temperature environment or long-term operation. Accordingly, the electrophoretic display apparatus 1 may reduce discomfort, afterimages, color changes, and increased power consumption due to changes in the electrical characteristics, and improve product life and reliability.

The electrophoretic display apparatus 1 according to one embodiment may detect in real time changes in electrical characteristics caused by charging/discharging of the capacitive load and the movement of charged color pigments.

However, when the controller 30 monitors in real time changes in electrical characteristics that occur due to the overall charging/discharging of the capacitive load and the movement of the charged color pigment, an excessive load may occur in the system.

Accordingly, the controller 30 may periodically collect changes in electrical characteristics that occur due to charging/discharging of the capacitive load and movement of the charged color pigment. For example, the controller 30 may secure changes in electrical characteristics that occur due to charging/discharging of the capacitive load and the movement of the charged color pigment in short-term cycles or long-term cycles such as hour/day/week/month/year.

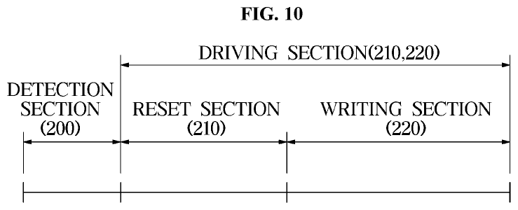

FIG. 10 illustrates a section for detecting changes in electrical characteristics during charging/discharging of a capacitive load in the electrophoretic display apparatus according to one embodiment.

Referring to FIG. 10, the entire section is divided into a detection section 200, a reset section 210, and a write section 220. A driving period 210 and 220 may include the reset section 210 and the write section 220.

Even when securing the entire current data and voltage data in the reset section 210 and the write section 220, an excessive load may occur on the system.

Accordingly, a separate detection section 200 may be provided so as not to affect the driving section 210 and 220. For example, the detection section may be provided separately in a previous section of the reset section 210 and the write section 220.

The controller 30 may collect the current data and the voltage data during charging/discharging of the capacitive load in the detection section 200. Therefore, the driving waveform used in the detection section 200 may be a waveform that best reflects changes in the electrical characteristics of the display panel 10. At this time, it is not limited to a specific voltage or waveform.

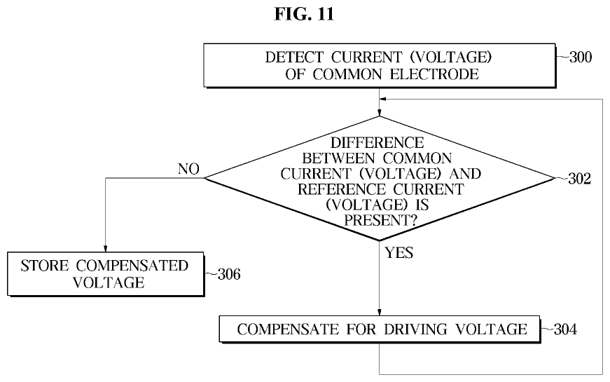

FIG. 11 illustrates compensation of a driving voltage supplied to the data driver in the electrophoretic display apparatus according to one embodiment.

Referring to FIG. 11, the controller 30 may detect at least one of the current and voltage of the common electrode 13 through the second sensor portion 80 (300).

The controller 30 may compare the current (voltage) of the common electrode 13 with an initial reference current (voltage) to determine whether a difference is present (302).

The controller 30 may compensate for the driving voltage supplied from the voltage compensator 50 to the data driver 22 (304) in response to the presence of the difference between the current (voltage) of the common electrode 13 and the reference current (voltage) (yes in 302).

The controller 30 may store the compensation voltage used for the driving voltage in the memory 32 (306) in response to the absence of the difference between the current (voltage) of the common electrode 13 and the reference current (voltage) (no in 302).

The current and voltage which are set at the initial state of the display panel 10 become weaker or faster as the display panel characteristics change over time and due to electrical stress. A compensation amount of the driving voltage supplied to the data driver 13 may be determined to return the current and voltage to the initial current and voltage of the common electrode 13. At this time, the amount of current entering the common electrode 13 is continuously detected, and the initial setting value is used as a reference value. For example, when a driving voltage of +15 V is supplied to the data driver 22, an initial current waveform entering the common electrode 13 is stored, and temporal and magnitude changes of the current waveform are detected after a period of time. This is because the TFT characteristics of the display panel 10 and the solvent and the charging characteristics of pigments change, and as a result, the movement characteristics of the pigments change, resulting in changes in speed or distance. Similarly, the current of the common electrode also changes in magnitude and time. The driving voltage is compensated to restore the voltage to the initial state. By sequentially adding +1V, +2V, +3V, and the like to the driving voltage, a value that reaches the most appropriate level is searched for and used as an optimal compensation value. In addition, when the phenomenon of the current waveform width increasing due to a response time delay occurs, additional compensation may be performed by varying a pulse width of the driving voltage. Through the process, the electrical characteristics of the display panel 10 may be maintained similar to the initial state.

The controller 30 may estimate and apply an appropriate compensation value for a change in the amount of charge generated in the capacitive load using preset waveforms and compensation data.

The controller 30 may periodically collect compensation results and perform optimization through additional compensation when necessary.

The controller 30 may calculate an amount of change by comparing the n-th previous data ((n−1)-th existing data) with the current n-th current data. A degree of change in the electrical characteristics of the display panel 10 may be calculated by comparing the amount of change with a preset panel characteristic lookup table

The controller 30 may obtain initialization data of the display panel 10 to be evaluated several times or for a certain period of time, and generate an additional lookup table based on the amount of change. This is because the panel characteristic lookup table is an averaged representative value obtained through a large-scale evaluation and may not match the characteristics of each product or unit panel.

In general, due to the electrical characteristics of the display panel 10, it is required to perform a process of comparing and accumulating long-term data on environmental and driving stress. Therefore, instead of storing the entire sampling data, the controller 30 may compare n-th data with (n−1)th . . . (nk)th data, and store the changed difference value two-dimensionally, and track the change trend thereafter using a statistical method. At this time, the sampling data may be divided into a set section, converted into a discrete level, and quantized by assigning a representative value to each section. A new additional lookup table may be generated with the quantized values, and repeatedly updated through continuous self-evaluation. The controller 30 may calculate a predicted value of n+1 based on the change trend, determine a compensation voltage based on the predicted value of n+1, and compensate for the driving voltage by applying the compensation voltage to the driving voltage through the voltage compensator 50.

In addition, even when the compensation voltage is applied for the (n+1) period using the compensation voltage table, it may not match the compensation characteristics for each product/unit panel. Therefore, the controller 30 may obtain the amount of change several times or for a certain period of time after application for the (n+1) period, and evaluate whether the compensation voltage is appropriate. In addition, when an under or over compensation voltage is present, a new compensation lookup table may be created and additionally applied to a driving section after (n+1) using the new compensation lookup table.

The controller 30 may change an application time or increase or decrease the number of unit pulses based on the final lookup table when the compensation voltage of the lookup table reaches a voltage range that may no longer be supplied by the voltage compensator 50 or when the effect of the voltage compensation is insufficient. The time of the driving pulse, the number of pulses, and the period of the driving section may be changed. The controller 30 may compensate for permanent color fading or changes in driving characteristics by increasing or decreasing the width and/or time of the driving unit pulse or increasing or decreasing the number of the application of unit pulses through pulse width modulation (PWM) control, and may compensate for or reduce the deterioration of the characteristics of the display panel 10.

According to the present disclosure, the product life and reliability of the electrophoretic display apparatus 1 may be improved.

An electrophoretic display apparatus 1 according to one embodiment may include a common electrode 13 supplied with a common voltage, a pixel electrode 12 arranged to correspond to the common electrode 13, a plurality of color pigments disposed between the common electrode 13 and the pixel electrode 12 and dispersed in a solvent, a data driver 22 configured to supply a data voltage to the pixel electrode 12, a voltage compensator 50 configured to compensate for a driving voltage supplied to the data driver 22, a first sensor portion 70 configured to detect a first detection data including at least one of a current and a voltage on a power side of the data driver, a second sensor portion 80 configured to detect a second detection data including at least one of a current and a voltage of the common electrode, a memory provided to accumulate and store the first detection data and the second detection data correspondingly, and a controller 30 configured to control the voltage compensator 50 to allow the first detection data and/or the second detection data to reach preset reference data based on the first detection data and the second detection data.

The voltage compensator 50 may include a plurality of voltage compensators 50. The plurality of voltage compensators 50 may be configured to supply a driving voltage of a plurality of voltage levels corresponding to a plurality of voltage levels of the data voltage to the data driver 22.

The voltage compensator 50 may be configured to supply the driving voltage to the data driver 22, and configured to perform a sourcing operation that supplies a current to the data driver 22 or a sinking operation that absorbs a current flowing from the data driver 22 based on a difference between a data voltage of a current frame and a data voltage of a previous frame.

The voltage compensator 50 may include a voltage adder configured to receive the driving voltage and a compensation voltage, which is provided from the controller 30, and add the driving voltage and the compensation voltage so as to generate a compensated voltage, an operational amplifier to which the compensated voltage is input from the voltage adder, and a current amplifier connected to the operational amplifier. The compensated voltage may be supplied to a non-inverting input terminal, a voltage of an output node of the current amplifier may be fed back to an inverting input terminal, and an output terminal may be connected to an input node of the current amplifier.

The current amplifier may include a first switching element Q1, a second switching element Q2 connected to the first switching element Q1, and a resistor R3 connected to the first switching element Q1 and the second switching element Q2. The first switching element Q1 may include an NPN switching element, and the second switching element Q2 may include a PNP switching element. One side of the resistor R3 may be commonly connected to the output terminal of the operational amplifier and bases of the first switching element Q1 and the second switching element Q2, and the other side of the resistor R3 may be commonly connected to emitters of the first switching element Q1 and the second switching element Q2.

The current amplifier may be provided in such a way that the first switching element Q1 is turned on and the second switching element Q2 is turned off so as to supply a current to the data driver 22 in response to a voltage difference formed at opposite ends of the resistor R3 by a current output from the operational amplifier to the data driver 22.

The current amplifier may be provided in such a way that the first switching element Q1 is turned off and the second switching element Q2 is turned on so as to absorb a current flowing from the data driver 22 in response to a voltage difference formed at opposite ends of the resistor R3 by a current flowing from the data driver 22 to the operational amplifier.

The electrophoretic display apparatus 1 may further include a stabilization circuit 60 configured to perform a sourcing operation that supplies a current to the common electrode 13 or a sinking operation that absorbs a current flowing from the common electrode 13 based on a difference between a data voltage of a current frame and a data voltage of a previous frame.

The stabilization circuit 60 may include an operational amplifier configured to receive the common voltage, and a current amplifier connected to the operational amplifier. The operational amplifier may be provided in such a way that the common voltage is supplied to a non-inverting input terminal, a voltage of an output node of the current amplifier is fed back to an inverting input terminal, and an output terminal is connected to an input node of the current amplifier.

The current amplifier may include a third switching element Q3, a fourth switching element Q4 connected to the third switching element Q3, and a resistor R4 connected to the third switching element Q3 and the fourth switching element Q4. The third switching element Q3 may include an NPN switching element, and the fourth switching element Q4 may include a PNP switching element. One side of the resistor R4 may be commonly connected to the output terminal of the operational amplifier and bases of the third switching element Q3 and the fourth switching element Q4, and the other side of the resistor R4 may be commonly connected to emitters of the third switching element Q3 and the fourth switching element Q4.

The current amplifier may be provided in such a way that the third switching element Q3 is turned off and the fourth switching element Q4 is turned on so as to absorb a current flowing from the common electrode 13 in response to a voltage difference formed at opposite ends of the resistor R4 by a current flowing into the operational amplifier from the common electrode 13.

The current amplifier may be provided in such a way that the third switching element Q3 is turned on and the fourth switching element Q4 is turned off so as to supply a current to the common electrode 13 in response to a voltage difference formed at opposite ends of the resistor R4 by a current supplied to the common electrode 13 from the operational amplifier.

The electrophoretic display apparatus 1 may further include a third sensor portion 90 configured to detect a third detection data including at least one of temperature and humidity of the data driver 22. The controller 30 may be configured to control the voltage compensator 50 to allow at least one of the first detection data and the second detection data to reach the preset reference data based on the first detection data, the second detection data, and the third detection data.

The controller 30 may be configured to compensate for the driving voltage through the voltage compensator 50 during a power booting stage, so as to compensate for the driving voltage before a driving section of the electrophoretic display apparatus starts.

The controller 30 may be configured to detect the first detection data and the second detection data in short-term cycles, such as hour/day/week/month/year, or long-term cycles through the first sensor portion 70 and the second sensor portion 80.

The controller 30 may be configured to detect the first detection data and the second detection data through the first sensor portion 70 and the second sensor portion 80 in a detection section provided before the driving section of the electrophoretic display apparatus.

The controller 30 may be configured to control at least one of an application time of the driving voltage, a width of a driving pulse of the driving voltage, and the number of the driving pulses through digital control.

The controller 30 may be configured to compare the first detection data and the second detection data detected through the first sensor portion 70 and the second sensor portion 80 with (n−1)-th data and n-th data to quantize an amount of change, store the quantized data in the memory, track a trend of an amount of change based on the quantized data, predict n+1 data based on the trend of the amount of change, determine a compensation voltage for compensating for the driving voltage based on the predicted (n+1) data, and compensate for the driving voltage based on the compensation voltage for an (n+1) period.

A method of controlling of an electrophoretic display apparatus 1 may include supplying a common voltage to a common electrode 13, supplying a driving voltage to a data driver 22 configured to supply a data voltage to a pixel electrode 12, supplying the data voltage to the pixel electrode 12, detecting a first detection data including at least one of a current and a voltage on a power side of the data driver, detecting a second detection data including at least one of a current and a voltage of the common electrode 13, accumulating and storing the first detection data and the second detection data correspondingly, and compensating for a driving voltage supplied to the data driver 22 to allow at least one of the first detection data and the second detection data to reach preset reference data based on the first detection data and the second detection data.

The method of controlling the electrophoretic display apparatus 1 may further include detecting a third detection data including at least one of temperature and humidity of the data driver 22. The compensating for the driving voltage may include compensating for a driving voltage supplied to the data driver 22 to allow at least one of the first detection data and the second detection data to reach the preset reference data based on the first detection data, the second detection data, and the third detection data.

Meanwhile, the disclosed embodiments may be embodied in the form of a recording medium storing instructions executable by a computer. The instructions may be stored in the form of program code and, when executed by a processor, may generate a program module to perform the operations of the disclosed embodiments. The recording medium may be embodied as a computer-readable recording medium.

The computer program may be stored in a non-transitory storage medium readable by a computer. Such media include read-only memory (ROM), random access memory (RAM), optical disk, hard disk drive, and the like. The computer program may be stored in advance in a storage medium or may be downloaded to the storage medium through a communication network including the internet or the like.

Storage medium readable by machine, may be provided in the form of a non-transitory storage medium. “Non-transitory” means that the storage medium is a tangible device and does not contain a signal (e.g., electromagnetic wave), and this term includes a case in which data is semi-permanently stored in a storage medium and a case in which data is temporarily stored in a storage medium. For example, “non-transitory storage medium” may include a buffer in which data is temporarily stored.

The method according to the various disclosed embodiments may be provided by being included in a computer program product. Computer program products may be traded between sellers and buyers as commodities. Computer program products are distributed in the form of a device-readable storage medium (e.g., compact disc read only memory (CD-ROM)), or are distributed directly or online (e.g., downloaded or uploaded) between two user devices (e.g., smartphones) through an application store (e.g., Play Store™). In the case of online distribution, at least a portion of the computer program product (e.g., downloadable app) may be temporarily stored or created temporarily in a device-readable storage medium such as the manufacturer's server, the application store's server, or the relay server's memory.

While the present disclosure has been particularly described with reference to exemplary embodiments, it should be understood by those of skilled in the art that various changes in form and details may be made without departing from the spirit and scope of the present disclosure.

1. An electrophoretic display apparatus to display images, comprising:
a common electrode supplied with a common voltage;
a pixel electrode arranged to correspond to the common electrode;
a plurality of color pigments between the common electrode and the pixel electrode and dispersed in a solvent;
a data driver configured to supply a data voltage of a frame, among data voltages of frames, of an image among the images, to the pixel electrode;
a voltage compensator configured to compensate for a driving voltage supplied to the data driver;
a first sensor portion configured to repeatedly detect a first detection data comprising at least one of a first current and a first voltage on a power side of the data driver;
a second sensor portion configured to repeatedly detect a second detection data comprising at least one of a second current and a second voltage of the common electrode;
a memory configured to accumulatively store the first detection data repeatedly detected in correspondence with the second detection data repeatedly detected as an accumulated first detection data and an accumulated second detection data; and
a controller configured to control the voltage compensator to compensate for the driving voltage supplied to the data driver by supplying a compensation voltage based on the accumulated first detection data and the accumulated second detection data to the data driver to allow at least one of the first detection data and the second detection data to reach a set reference data.

2. The electrophoretic display apparatus of claim 1, wherein
the voltage compensator is among a plurality of voltage compensators, and
the controller is further configured to respectively control the plurality of voltage compensators to compensate for a respective driving voltage of a plurality of voltage levels of the data voltage supplied to the data driver, such that the plurality of voltage compensators are configured to supply the respective driving voltage of the plurality of voltage levels corresponding to the data voltage to the data driver.

3. The electrophoretic display apparatus of claim 1, wherein
the voltage compensator is configured to
supply the driving voltage to the data driver, and
perform at least one operation among operations including a sourcing operation that supplies a charging current to the data driver or a sinking operation that absorbs a discharging current flowing from the data driver based on a difference between a data voltage of a current frame among the frames and a data voltage of a previous frame among the frames.

4. The electrophoretic display apparatus of claim 1, wherein
the voltage compensator comprises:
a voltage adder configured to receive the driving voltage and the compensation voltage, and add the driving voltage and the compensation voltage so as to generate a compensated voltage;
an operational amplifier configured to receive the compensated voltage from the voltage adder; and
a current amplifier connected to the operational amplifier,
wherein
the compensated voltage is supplied to a non-inverting input terminal of the operational amplifier, an output voltage of an output node of the current amplifier is fed back to an inverting input terminal of the operational amplifier, and an output terminal of the operational amplifier is connected to an input node of the current amplifier.

5. The electrophoretic display apparatus of claim 4, wherein
the current amplifier comprises:
a first switching element having a first base and a first emitter;
a second switching element having a second base and a second emitter and being connected to the first switching element; and
a resistor having a first side and a second side connected to the first switching element and the second switching element, respectively,
wherein
the first switching element comprises an NPN switching element, and the second switching element comprises a PNP switching element,
the first side of the resistor and the first base of the first switching element and the second base of the second switching element are commonly connected to the output terminal of the operational amplifier, and
the second side of the resistor is commonly connected to the first emitter of the first switching element and the second emitter of the second switching element.

6. The electrophoretic display apparatus of claim 5, wherein
the current amplifier is configured such that the first switching element is turned on and the second switching element is turned off so as to supply a charging current to the data driver in response to a voltage difference formed between the first side of the resistor and the second side of the resistor by a charging current output from the operational amplifier to the data driver.

7. The electrophoretic display apparatus of claim 5, wherein
the current amplifier is configured such that the first switching element is turned off and the second switching element is turned on so as to absorb a discharging current flowing from the data driver in response to a voltage difference formed between the first side of the resistor and the second side of the resistor by the discharging current flowing from the data driver to the operational amplifier.

8. The electrophoretic display apparatus of claim 1, further comprising:
a stabilization circuit configured to perform a sourcing operation that supplies a charging current to the common electrode and/or a sinking operation that absorbs a discharging current flowing from the common electrode based on a difference between a data voltage of a current frame among the frames and a data voltage of a previous frame among the frames.

9. The electrophoretic display apparatus of claim 8, wherein
the stabilization circuit comprises:
an operational amplifier configured to receive the common voltage; and
a current amplifier connected to the operational amplifier,
wherein the common voltage is supplied to a non-inverting input terminal of the operational amplifier, an output voltage of an output node of the current amplifier is fed back to an inverting input terminal of the operational amplifier, and an output terminal of the operational amplifier is connected to an input node of the current amplifier.

10. The electrophoretic display apparatus of claim 9, wherein
the current amplifier comprises:
a third switching element having a third base and a third emitter;
a fourth switching element having a fourth base and a fourth emitter and being connected to the third switching element; and
a resistor having a first side and a second side connected to the third switching element and the fourth switching element,
wherein the third switching element comprises an NPN switching element, and the fourth switching element comprises a PNP switching element,
wherein the first side of the resistor and the third base of the third switching element and the fourth base of the fourth switching element are commonly connected to the output terminal of the operational amplifier, and the second side of the resistor is commonly connected to the third emitter of the third switching element and the fourth emitter of the fourth switching element (Q4).

11. The electrophoretic display apparatus of claim 10, wherein
the current amplifier is configured such that the third switching element is turned off and the fourth switching element is turned on so as to absorb the discharging current flowing from the common electrode in response to a voltage difference between first and second sides of the resistor by the discharging current flowing into the operational amplifier from the common electrode.

12. The electrophoretic display apparatus of claim 10, wherein
the current amplifier is provided in such a way that the third switching element is turned on and the fourth switching element is turned off so as to supply the charging current to the common electrode in response to a voltage difference between first and second sides of the resistor by the charging current supplied to the common electrode from the operational amplifier.

13. The electrophoretic display apparatus of claim 1, further comprising:
a third sensor portion configured to repeatedly detect a third detection data comprising at least one of a temperature and a humidity of the data driver,
wherein the memory is configured to accumulatively store the third detection data repeatedly detected as an accumulated third detection data, and
wherein the controller is configured to control the voltage compensator to compensate for the driving voltage supplied to the data driver by supplying the compensation voltage based on the accumulated first detection data, the accumulated second detection data, and the accumulated third detection data to the data driver to allow at least one of the first detection data and the second detection data to reach the set reference data.

14. The electrophoretic display apparatus of claim 1, wherein
the controller is configured to compensate for the driving voltage through the voltage compensator during a power booting stage so as to compensate for the driving voltage before a driving section of the electrophoretic display apparatus starts.

15. The electrophoretic display apparatus of claim 1, wherein
the controller is configured to detect the first detection data and the second detection data in short-term cycles, such as hour/day/week/month/year, and/or long-term cycles through the first sensor portion and the second sensor portion.
